(19) United States
(12) Patent Application Publication
(10) Pub. No.: US 2009/0173430 A1
(43) Pub. Date: Jul. 9, 2009

(54) PROCESS FOR FILM APPLICATION

(76) Inventor: Johannes Georg Schaede, Würzburg (DE)

Correspondence Address: CROMPTON, SEAGER & TUFTE, LLC, 1221 NICOLLET AVENUE, SUITE 800, MINNEAPOLIS, MN, 55403-2420, US

(21) Appl. No.: 10/584,881

(22) PCT Filed: Jan. 5, 2005
(86) PCT No.: PCT/IB05/00013

§ 371 Date: Jun. 28, 2006

(30) Foreign Application Priority Data
Jan. 8, 2004 (EP) 04000263.6

(51) Int. Cl. B32B 43/00; B32B 38/10

(52) U.S. Cl. 156/108; 156/253

(57) ABSTRACT

The process comprises the following steps: —) deposition of a glueing material on the substrate; —) cutting of a window into the substrate and into the deposited glueing material; —) application of a layer of material at least over the cut window and activation of the glueing material.

The present invention concerns a process for a film application on a substrate, such a paper substrate or similar substrate used for securities.

In the field of banknotes and securities, there has been increasing needs for safety features protecting against counterfeiting. Indeed, in the past years, computers, scanners and copy machines have been extensively developed and today, it is possible to buy very performant devices at a reasonable price. Since these devices are more performant, it has been at the same time necessary to develop new and improved safety features for securities, such as banknotes, checks, cards (i.e. credit cards), ID cards, passports etc. which would not allow them to be copied by standard computers or scanners, or even modern color copy machines.

Such safety features include special inks, so called optical variable inks (OVI®), used to print specific patterns on the substrate of the note, optical variable devices (OVD®) in the shape of metallized patches or holograms, or also specific patterns, such as moiré patterns and other similar patterns, all of which are very difficult if not impossible to copy with actual devices, but, on the other hand, are easy to control visually.

Other safety means include combinations of superimposed lines and/or patterns with colors, which are only visible under specific conditions, for example UV light or by transparency. Again, the interest of such safety means is that they may easily be printed or placed on the document to be protected and also be controlled by simple devices, even visually with the naked eye, but they are impossible to reproduce with actual printers, scanners or copy machines.

Another specific technique involves watermarks in which the paper substrate is marked with lines or patterns only visible in transparency. A further development of this technique concerns pseudo-watermarks consisting in the creation of a window in the substrate, especially in paper-based substrates, which are normally not transparent, said window being transparent.

It is however very difficult to create or simulate a transparent window in a paper-based substrate. Transparent windows, as such, are widely used in polymer-based substrates for banknotes and securities, in order to provide a security element. These polymer-based substrates are usually completely transparent, therefore, to form a transparent window, it is only necessary to leave the chosen zone free of printing. However, in the case of paper, a substrate which is not transparent, a first process has been developed according to which, it is possible to reduce locally the thickness of the paper in order to create a transparent window in the substrate. PCT application WO 99/14433 for example, discloses this process and the content of this application is incorporated by reference in the present application. According to this known process, a soaking solution is applied on at least one surface of the paper in one or several predetermined zones, then one applies pressure and heat on the soaked zone so as to evaporate and densify the coated paper in said zone relative to the rest of the paper. Thus, said zones have a reduced thickness with respect to the rest of the paper and are transparent.

This first technique however has the drawback of weakening locally the paper in the zone comprising said window. In particular, the smaller the thickness of the window, the weaker the zone. Banknotes using such a technique thus have a reduced lifetime and must be exchanged, i.e. new bank notes must be printed to replace the older damaged ones.

Another technique Implies to cut a hole directly in the paper in order to create the transparent window. For example, PCT application WO 95/10420, the content of which is incorporated by reference in the present application, discloses said other technique. It is of course necessary to cover the hole cut in the substrate, which is done in this case by covering the hole with a strip of transparent material, e.g. a foil or a laminate. This document specifically uses the contrast between the transparency of the window and a diffraction structure used as an additional security feature and placed inside the window. Modern copy machines and scanners are indeed unable to copy a diffraction structure and also a transparent window.

A known process for reinforcing a substrate is known from European patent application 1 398 174, the content of which is enclosed by reference in the present application, in which a substrate having a zone of reduced thickness, for example a hole, comprises reinforcing means formed by a transparent polymer material, in particular a foil, covering said zone.

Another publication disclosing a security document comprising a window sealed off by an at least transparent foil is the international application WO 95/10420, incorporated herein by reference.

European patent application No 1 361 028 discloses a mechanical machine for cutting openings, such as windows, in a substrate. The content of this application is incorporated by reference in the present application for its disclosure of the cutting machine and process used.

U.S. Pat. No. 4,531,765 discloses color coded ID cards formed by laminated documents, including a color-coded protective assembly comprising a pigment composition integrated with an adhesive bond within the assembly. According to the teaching of this prior art patent, the document comprises a pouch structure comprising inter alia a recess and a colourless transparent polyester cover sheet entirely coated with an adhesive also over the recess.

However, the known processes and devices have certain disadvantages.

For example such as taught by U.S. Pat. No. 4,531,765, if the glueing material is present on the foil that is applied on the substrate, when a window is present in the substrate, the glueing material may then be transferred to other parts of the machine, which will then have to be cleaned.

It is therefore an aim of the present invention to improve the known processes and machines.

A further aim of the present invention is to provide a process in which a foil can be applied onto a substrate with a window in a safe and precise manner.

Another aim of the present invention is to provide a process in which the contamination of the machines by the glueing material is brought to a minimum.

To this effect, the invention complies with the definition of the claims.

An advantage of the invention is that the cutting into the substrate and the predeposited glueing material will give perfect registration between window and glueing material.

Another advantage of the process according to the invention is the fact that the glueing material on the window edge prevents a peeling of the window edge.

A further advantage is that the layer of material, for example a laminate, carries no glueing material and for this reason will not stick to a thermo transfer tool in the window area.

The invention will be best understood with the description of an example of process and with reference to the accompanying drawings in which:

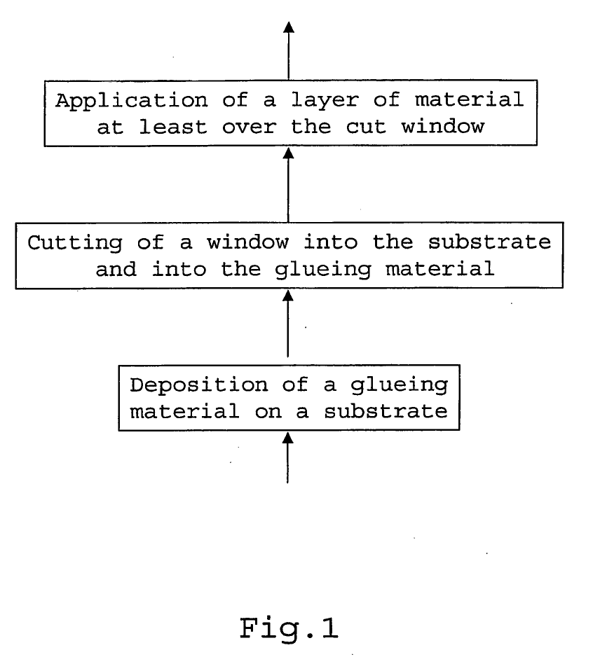

FIG. 1 is a block-diagram of the process according to the invention;

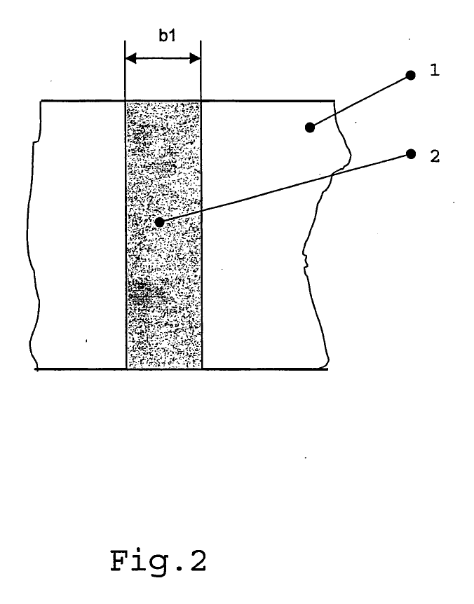

FIG. 2 is a schematical representation of the first step of the process according to the invention;

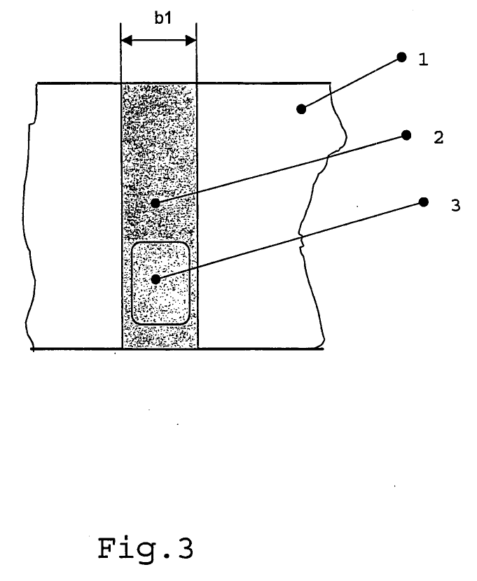

FIG. 3 is schematical representation of the second step of the process according to the invention;

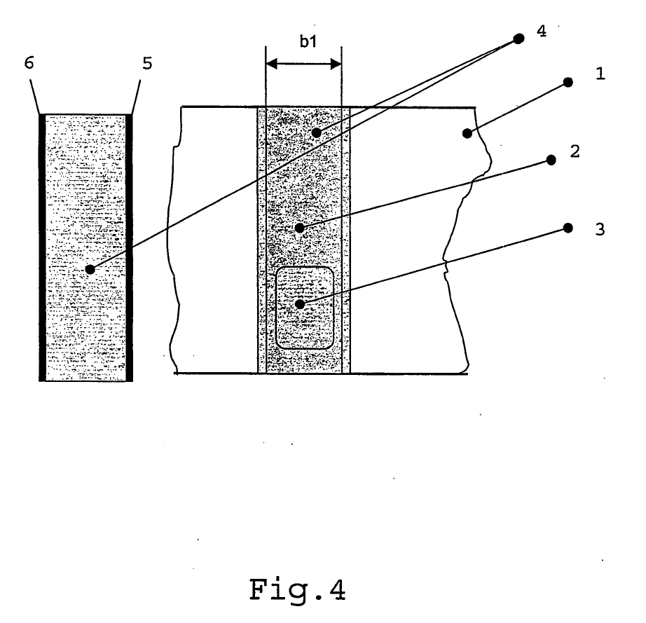

FIG. 4 is schematical representation of the third step of the process according to the invention and

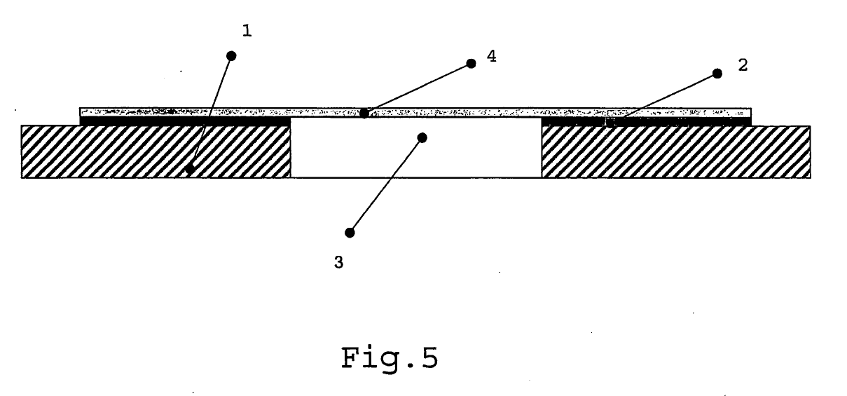

FIG. 5 is a cross section of a substrate produced with the process according to the invention.

As shown in the figures, the process comprises the first step of deposition of a glueing material on the substrate 1 (see FIG. 1). The substrate may be a paper substrate, such as used to form securities, bank notes passports, checks or tickets and other similar products.

The substrate 1 may also be a polymer substrate such as a used for cards, credit cards, bankcards, or also a polymer substrate used for securities.

As one can readily understand, the substrate 1 is usually, but not limited thereto, a printed substrate.

The glueing material, preferably a thermo transfer glue that is known in the art, is deposited as a strip 2 onto the substrate 1, as represented in FIG. 2. Many deposition processes known in the art can be used for the deposition of the glueing material, for example a screen deposition process.

The width b1 of the strip is defined by the width of the strip of material that will be glued to the substrate 1.

As a second step (see FIGS. 1 and 3) a window 3 is cut into the substrate 1 and into the deposited strip of glueing material 2.

The cutting process can be a laser cutting process, as disclosed in EP application No 03009986.5 filed on May 2, 2003 in the name of KBA-GIORI S.A. or a mechanical cutting process as disclosed in EP application No 1 361 028 mentioned above, both incorporated by reference in the present application for the sake of completeness of the widow cutting process.

As a third step (see FIGS. 1 and 4) the process comprises the application of a layer of material 4 at least over the cut window 3 and the activation of the glueing material.

Preferably, the layer of material 4 is a laminate strip. As shown in FIG. 4, the laminate strip preferably comprises two additional lateral strips of glueing material 5 and 6, made of thermo transfer glue, said lateral strips allowing to properly attach the peripheral zone of the layer of material 4 to the substrate 1.

The activation of the glueing material can be made by different processes, which depend on the glueing material used. For example, one can use heat as an activating means with a thermo glue, or one could use a two component glue whereby the one component located on the layer of material 4 in the window would not be activated, or one could use an UV activated glue, or any other suitable glueing material with its activation process.

FIG. 5 shows schematically a cross section of a substrate obtained by the process according to the invention with the substrate 1, for example a security, with a window 3 cut into the substrate and into a glueing material 3, covered by a layer of material 4, e.g. a laminate strip.

Of course, the present invention is not limited to the examples given but other equivalent designs are possible within the scope of protection. For example, the strip of material may have different shapes, such as a patch, a square or round strip or an elongated strip.

1. Process for a film application on a substrate used for securities, such as a paper substrate or other similar substrate, comprising the following steps:
deposition of a glueing material on the substrate;
cutting of a window into the substrate and into the deposited glueing material;
application of a layer of material at least over the cut window, said layer carrying no glueing material in the region where it overlies said window and
activation of the glueing material.

2. A process according to claim 1, wherein a zone of said layer of material facing said substrate, outside the region where the layer of material overlies the window, is provided with a glueing material for cooperation with the glueing material deposited onto the substrate.

3. A process according to claim 2, wherein said layer of material is provided with said glueing material at least in a peripheral zone facing said substrate to provide proper attachment of said peripheral zone to said substrate.

4. A process according to claim 3, in which the glueing material is a thermo transfer glue.

5. A process according to claim 1, in which said cutting step is carried out by a laser.

6. A process according to claim 3, in which said layer of material is a strip of laminate.

7. A process according to claim 3, in which the activation of the glueing material is made by heat or by UV.

8. A process according to claim 3, in which said substrate is a paper substrate.

9. A process according to claim 3, in which said substrate is a polymer substrate.

10. A process according to claim 8, in which the substrate is a printed substrate.

11. A process according to claim 9, in which the substrate is a printed substrate.

12. A process according to claim 3, in which said cutting step is carried out by a knife.
